(19) United States
(12) Patent Application Publication
(10) Pub. No.: US 2026/0239405 A1
(43) Pub. Date: Aug. 13, 2026

(54) COLLISION HANDLING

(71) Applicant: Nokia Technologies Oy, Espoo (FI)

(72) Inventors: Nhat-Quang NHAN, Reims (FR); Jie GAO, Zhejiang (CN); Jing Yuan SUN, Beijing (CN); Youngsoo YUK, Seoul (KR); Erika PORTELA LOPES DE ALMEIDA, Aalborg (DK)

(21) Appl. No.: 19/168,908

(22) PCT Filed: Apr. 6, 2023
(86) PCT No.: PCT/CN2023/086428

§ 371 Date: Sep. 25, 2025

(51) Int. Cl. H04W 72/541; H04L 5/14; H04W 72/1263; H04W 72/566

(52) U.S. Cl. CPC H04W 72/541; H04L 5/14; H04W 72/1263; H04W 72/566

(57) ABSTRACT

Example embodiments of the present disclosure relate to applying timing advance during random access procedure. The first apparatus receives configuration information from a second apparatus, where the configuration information indicates at least one of a first set of resources of a plurality of resources or a second set of resources of the plurality of resources, the first and second sets of resources are associated with a first and second collision rules respectively, and the first and second collision rules are used for handling a collision between a first communication direction and a second communication direction. Further, the first apparatus detects a collision occurring on a resource of the plurality of resources; and performs, communications with the second apparatus on the resource based at least in part on the configuration information.

### FIELDS

Various example embodiments of the present disclosure generally relate to the field of telecommunication and in particular, to methods, devices, apparatuses and computer readable storage medium for collision handling.

### BACKGROUND

Currently, the new radio (NR) supports two duplexing modes: Frequency Division Duplex (FDD) for paired bands and Time Division Duplex (TDD) for unpaired bands. In TDD, the time domain resource is split between downlink (DL) and uplink (UL). Allocation of a limited time duration for the uplink in TDD would result in reduced coverage, increased latency, and reduced capacity.

To address the challenges above, a study on the evolution of duplexing operation in NR has been initiated. Subband non-overlapping full duplex (SBFD) has been proposed as a scheme of an enhanced duplex operation. In the SBFD, simultaneous DL transmission and UL reception at a NR NodeB (also referred to as a gNB) on different physical resource blocks (PRBs) within an unpaired wideband NR cell is allowed. This duplexing scheme is also referred to as cross-division duplexing (xDD) or Flexible Duplexing (FDU).

### SUMMARY

In a first aspect of the present disclosure, there is provided a first device. The first device comprises at least one processor; and at least one memory storing instructions that, when executed by the at least one processor, cause the first apparatus at least to performing: receiving, from a second apparatus, configuration information indicating at least one of a first set of resources of a plurality of resources or a second set of resources of the plurality of resources, the first and second sets of resources associated with a first and second collision rules respectively, the first and second collision rules used for handling a collision between a first communication direction and a second communication direction; detecting a collision occurring on a resource of the plurality of resources; and performing, communications with the second apparatus on the resource based at least in part on the configuration information.

In a second aspect of the present disclosure, there is provided a second device. The second device comprises at least one processor; and at least one memory storing instructions that, when executed by the at least one processor, cause the second apparatus at least to: transmitting, to a first apparatus, configuration information indicating at least one of a first set of resources of a plurality of resources or a second set of resources of the plurality of resources, the first and second sets of resources associated with a first and second collision rules respectively, the first and second collision rules used for handling a collision between a first communication direction and a second communication direction; detecting the collision occurring on a resource of the plurality of resources; and performing, communications with the second apparatus on the resource based at least in part on the configuration information.

In a third aspect of the present disclosure, there is provided a method. The method comprises: at a first device, receiving, from a second apparatus, configuration information indicating at least one of a first set of resources of a plurality of resources or a second set of resources of the plurality of resources, the first and second sets of resources associated with a first and second collision rules respectively, the first and second collision rules used for handling a collision between a first communication direction and a second communication direction; detecting a collision occurring on a resource of the plurality of resources; and performing, communications with the second apparatus on the resource based at least in part on the configuration information.

In a fourth aspect of the present disclosure, there is provided a method. The method comprises: at a second device, transmitting, to a first apparatus, configuration information indicating at least one of a first set of resources of a plurality of resources or a second set of resources of the plurality of resources, the first and second sets of resources associated with a first and second collision rules respectively, the first and second collision rules used for handling a collision between a first communication direction and a second communication direction; detecting the collision occurring on a resource of the plurality of resources; and performing, communications with the second apparatus on the resource based at least in part on the configuration information.

In a fifth aspect of the present disclosure, there is provided a first apparatus. The first apparatus comprises means for receiving, from a second apparatus, configuration information indicating at least one of a first set of resources of a plurality of resources or a second set of resources of the plurality of resources, the first and second sets of resources associated with a first and second collision rules respectively, the first and second collision rules used for handling a collision between a first communication direction and a second communication direction; means for detecting a collision occurring on a resource of the plurality of resources; and means for performing, communications with the second apparatus on the resource based at least in part on the configuration information.

In a sixth aspect of the present disclosure, there is provided a second apparatus. The second apparatus comprises means for transmitting, to a first apparatus, configuration information indicating at least one of a first set of resources of a plurality of resources or a second set of resources of the plurality of resources, the first and second sets of resources associated with a first and second collision rules respectively, the first and second collision rules used for handling a collision between a first communication direction and a second communication direction; means for detecting the collision occurring on a resource of the plurality of resources; and means for performing, communications with the second apparatus on the resource based at least in part on the configuration information.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example communication environment in which example embodiments of the present disclosure can be implemented;

FIG. 1B illustrates a block of example duplexing modes;

FIG. 1C illustrates a block of SBFD resources and non-SBFD resources;

FIG. 2 illustrates signaling chart of RA-related transmissions according to some example embodiments of the present disclosure;

FIG. 3 illustrates a block of example resources configuration;

FIG. 4 illustrates a flowchart of a method implemented at a first device according to some example embodiments of the present disclosure;

FIG. 5 illustrates a flowchart of a method implemented at a first device according to some example embodiments of the present disclosure;

FIG. 6 illustrates a flowchart of a method implemented at a second device according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like.

In the following, a resource in time domain will be used as an example of a resource for describing some example embodiments of the present disclosure. It is noted that example embodiments of the present disclosure are equally applicable to other resources in other domains. In summary, the resource used herein includes but is not limited to a time resource or a frequency resource, for example, a subband non-overlapping full duplex time resource, a dynamic time division duplexing time resource, a full duplex evolution time resource, a sub-band, a sub-carrier, or a resource element (RE).

Currently, it is expected to study the SBFD and potential enhancements on dynamic/flexible TDD. For example,
identify possible schemes and evaluate their feasibility and performances,
study inter-gNB and inter-UE cross link interference (CLI) handling and identify solutions to manage them,
consider intra-subband CLI and inter-subband CLI in case of the subband non-Overlapping full duplex,
study the performance of the identified schemes as well as the impact on legacy operation assuming their co-existence in co-channel and adjacent channels, study the feasibility of and impact on RF requirements considering adjacent-channel co-existence with the legacy operation,
study the feasibility of and impact on RF requirements considering the self-interference, the inter-subband CLI, and the inter-operator CLI at gNB and the inter-subband CLI and inter-operator CLI at UE.

Further, in some embodiments, it is assumed that the duplex enhancement is supported at the network device and the half duplex operation is supported at the terminal device. In addition, there is no restriction on frequency ranges.

Due to the half duplex operation at the terminal device, a collision may occur sometimes. Specifically, as for SBFD operation, with the appearance of both UL and DL sub-bands in SBFD slots, there exists the potential collision between DL and UL transmissions. Depending on whether a UL/DL transmission is dynamically scheduled or semi-statically configured via RRC signalling, the collision can be classified into the following scenarios:
Scenario 1: Dynamic DL transmission vs. dynamic UL transmission;
Scenario 2: Semi-static DL transmission vs. dynamic UL transmission;
Scenario 3: Dynamic DL transmission vs. semi-static UL transmission;
Scenario 4: Semi-static DL transmission vs. semi-static UL transmission.

In some embodiments, the above Scenario 1 may be considered as an error case since the network device would not dynamically schedule two transmissions to be collided. By contrast, Scenarios 2-4 are valid given that at least one of the transmissions is semi-statically configured. This provides flexibility for the scheduler, given that it may be challenging to always avoid the semi-statically configured resources.

In some embodiments, since the motivation of introducing SBFD operation is to improve UL performance and latency, it is straightforward that dynamic UL transmission should be prioritized in Scenario 2, at least in case the UL and DL transmissions have the same priority level, assuming that the UL is dynamically scheduled for critical UL traffic and the network is aware of the traffic in the semi-statically configured DL resources. However, such operation lack flexibility and cannot adapt to the actual communication scenario.

Further, collision handlings for Scenarios 3 and 4 are not straightforward (especially when priority index is considered). The embodiments discussed in this the present disclosure would especially benefit Scenarios 3 and 4.

Further, possible implementations for handling the new collision type (i.e., between DL and UL transmissions in SBFD slots) are focused on either dropping DL or UL transmission. For example, the DL transmission is mainly dropped due to the argument that UL subband in SBFD slots are used for improving coverage thus UL transmission should be prioritized. However, there are use cases wherein DL transmissions should also be prioritized e.g., some specific PDCCH occasions, or high priority PDSCH, etc. This shows that it is too restrictive if rules are fixed such that DL or UL transmissions are always dropped in SBFD slots.

In some other possible implementations for handling the new collision type, the network device may indicate explicitly, or implicitly which channel should be prioritized by the first apparatus. Specifically, a set of starting symbols in a slot or a set of RBs in frequency domain is specified, wherein DL transmission is associated with the option of entire dropping, and another set of starting symbols in a slot or another set of RBs in frequency domain is specified, wherein DL transmission is associated with the option of partial dropping. However, such solution limits the scheduling flexibility for the DL transmission, given that starting symbols/and or RBs need to be carefully selected for the DL transmission. Further, it is not very straightforward for the semi-static DL transmission, wherein the resource needs to be preconfigured.

In view of the above discussions, it is desirable to propose a more practicable and flexible solution for collision handling.

According to the present disclosure, the first apparatus receives configuration information from a second apparatus, where the configuration information indicates at least one of a first set of resources of a plurality of resources or a second set of resources of the plurality of resources, the first and second sets of resources are associated with a first and second collision rules respectively, and the first and second collision rules are used for handling a collision between a first communication direction and a second communication direction. Further, the first apparatus detects a collision occurring on a resource of the plurality of resources; and performs, communications with the second apparatus on the resource based at least in part on the configuration information.

In this way, a more practicable and flexible solution for collision handling is achieved.

### Example Environment

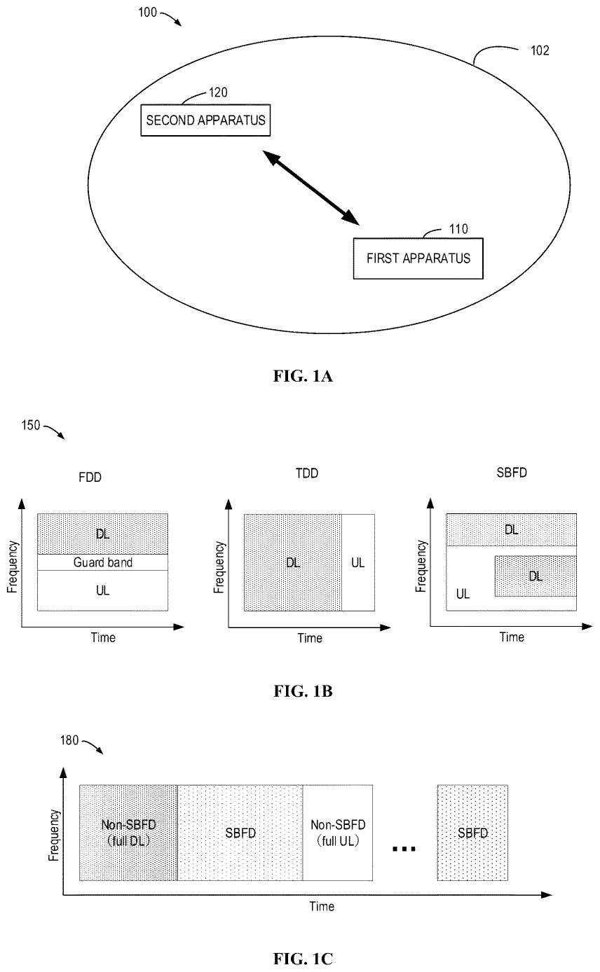

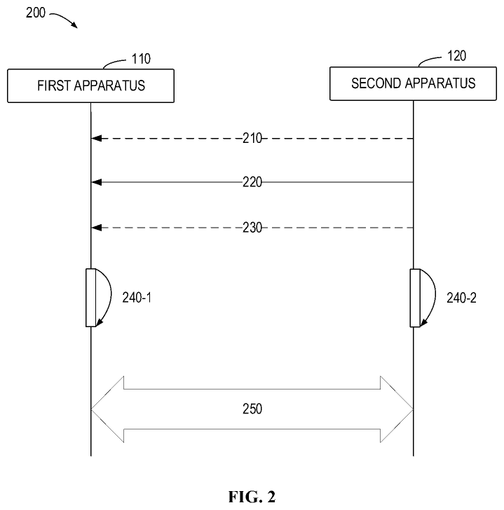

FIG. 1A illustrates an example communication environment 100 in which example embodiments of the present disclosure can be implemented. The communication environment 100 includes a first apparatus 110 and a second apparatus 120. A serving area provided by the second apparatus 120 is called a cell. The second apparatus 120 can provide one or more cells, for example, a cell 102 as illustrated in FIG. 1A.

In some example embodiments, the first apparatus 110 may be comprised in a terminal device and the second apparatus 120 may be comprised in a network device serving the terminal apparatus.

In the following, for the purpose of illustration, some example embodiments are described with the first apparatus 110 operating as a terminal apparatus and the second apparatus 120 operating as a network apparatus. However, in some example embodiments, operations described in connection with a terminal apparatus may be implemented at a network apparatus or other apparatus, and operations described in connection with a network apparatus may be implemented at a terminal apparatus or other apparatus.

In some example embodiments, if the first apparatus 110 is a terminal apparatus and the second apparatus 120 is a network apparatus, a link from the second apparatus 120 to the first apparatus 110 is referred to as a downlink (DL), while a link from the first apparatus 110 to the second apparatus 120 is referred to as an uplink (UL). In DL, the second apparatus 120 is a transmitting (TX) apparatus (or a transmitter) and the first apparatus 110 is a receiving (RX) apparatus (or a receiver). In UL, the first apparatus 110 is a TX apparatus (or a transmitter) and the second apparatus 120 is a RX apparatus (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Multiple duplexing modes may be supported in communication environment 100. Reference is now made to FIG. 1B, which illustrates a block 150 of three example duplexing modes, i.e., TDD, FDD and SBFD.

The FDD may be used for paired bands and TDD may be used for unpaired bands. In TDD, the time domain resource is split between downlink and uplink. Allocation of a limited time duration for the uplink in TDD would result in reduced coverage, increased latency, and reduced capacity. The SBFD may be considered as an evolution of duplexing operation in NR. In particular, the SBFD may allow simultaneous DL and UL transmission on different physical resource blocks (PRBs)/sub-bands within an unpaired wideband NR cell, as illustrated in FIG. 1B.

Further, different duplexing modes may be used interactively. In view of this, there may be two resource types for both DL and UL transmissions, namely:
SBFD resources (such as, slots), during which the non-overlapping DL sub-bands and UL subband(s) both exist, and
Non-SBFD (such as, slots), during which the entire band is used for either DL or UL (i.e., full DL/UL slots).

For better understanding, reference is now made to FIG. 1C, which illustrates a block 170 of SBFD resources and non-SBFD resources.

In some embodiments, at least the operation mode with time and frequency locations of sub-bands for SBFD operation may be known to the SBFD-aware UE. That is, the SBFD slots should be known by the (SBFD-aware) UE in one way or another.

### Work Principle and Example Signaling for Communication

According to some example embodiments of the present disclosure, there is provided a solution for collision handling.

In summary, the second apparatus may indicate different collision handling for different resources. That is, in the present disclosure, different collision handling rules may be used for different sets of resources.

Reference is made to FIG. 2, which illustrates a signaling flow 200 of communication in accordance with some embodiments of the present disclosure. For the purposes of discussion, the signaling flow 200 will be discussed with reference to FIG. 1, for example, by using the first apparatus 110 and the second apparatus 120.

It is to be understood that the operations at the first apparatus 110 and the second apparatus 120 should be coordinated. In other words, the second apparatus 120 and the first apparatus 110 should have common understanding about configurations, parameters and so on. Such common understanding may be implemented by any suitable interactions between the second apparatus 120 and the first apparatus 110 or both the second apparatus 120 and the first apparatus 110 applying the same rule/policy.

In the following, although some operations are described from a perspective of the first apparatus 110, it is to be understood that the corresponding operations should be performed by the second apparatus 120. Similarly, although some operations are described from a perspective of the second apparatus 120, it is to be understood that the corresponding operations should be performed by the first apparatus 110. Merely for brevity, some of the same or similar contents are omitted here.

In the example of FIG. 2, the first apparatus 110 is a terminal apparatus and the second apparatus 120 is a network apparatus.

Further, in the example of FIG. 2, the resources may be either resources in time domain or resources in frequency. Specifically, the plurality of resources may be one the following: a plurality of subband non-overlapping full duplex time and/or frequency resources, a plurality of dynamic time division duplexing time resources, a plurality of full duplex evolution time resources, a plurality of sub-bands, a plurality of sub-carriers, or a plurality of resource elements in frequency and/or in time domain.

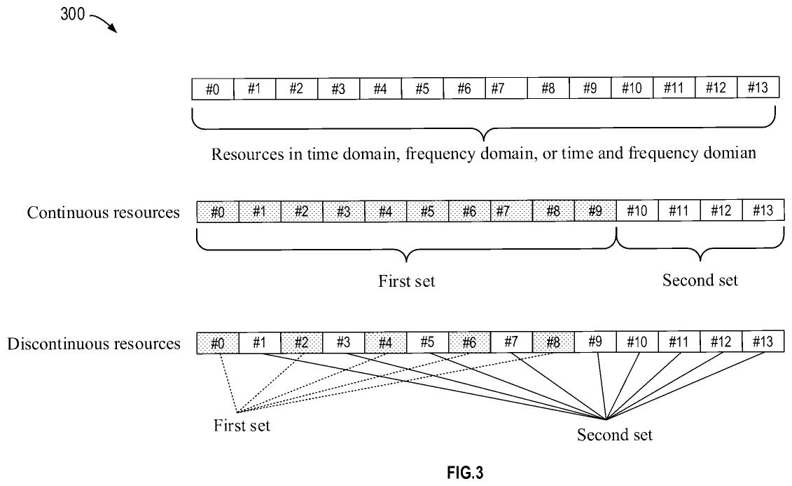

In some example embodiments, resources comprised in any of the first and second sets of resources are continuous or discontinuous. For better understanding, reference is now made to FIG. 3, which illustrates a block 300 of example resources configuration.

It should be understood, FIG. 3 is illustrated only for the purpose of illustration without suggesting any limitations. In other example embodiments, the total number of resources, the number of resources in the first set, the number of resources in the second set and the resource mapping may be changed.

In operation, the first apparatus 110 receives 220 configuration information from a second apparatus 120. The configuration information indicates at least one of a first set of resources of a plurality of resources or a second set of resources of the plurality of resources, the first and second sets of resources are associated with a first and second collision rules respectively, and the first and second collision rules are used for handling a collision between a first communication direction and a second communication direction.

As one example embodiment, the second apparatus 120 may indicate an indication (e.g., via RRC) indicating a first set of SBFD slots and a second set of SBFD slots, wherein different collision handling rules are applied for the collisions between DL and UL transmissions in the first and the second sets.

In some example embodiments, the configuration information comprises: a number M, indicating that the first M or the last M resources of the plurality of resources belong to the first set of resource and other resources of the plurality of resources belong to the second set of resources.

As one example embodiment, the second apparatus 120 may indicate a number of M slots, starting from the first slot in a bundle of N SBFD slots, wherein M is indicative of the slots in the first set. The remaining (N−M) slots belong to the second set.

In some example embodiments, the configuration information comprises: a bitmap of the plurality of resources, each bit in the bitmap corresponding to a resource, and wherein a first value of the bit indicates the corresponding resource belongs to the first set of resource and a second value of the bit indicates the corresponding resource belongs to the second set of resource.

As one example embodiment, the second apparatus 120 may indicate a bitmap of size N, wherein each bit in the bitmap is associated to a slot in the bundle of N SBFD slots, and wherein binary value of the bit indicates that the corresponding slot belongs to the first or the second set (e.g., 1 corresponds to first set, 0 corresponds to second set, or vice versa).

In some example embodiments, the configuration information further comprises an indication used for activating at least one of the first and second collision rules.

In some example embodiments, if the configuration information does not comprise explicit information indicating at least one of the first and second sets of resources, the at least one memory and the at least one processor further cause the first apparatus 110 to perform: determine the at least one of the first and second sets of resources according to a default configuration.

In some example embodiments, any of the first and second collision rules is used for processing a collision among different communication directions (such as, DL or UL).

Alternatively, or in addition, in some example embodiments, any of the first and second collision rules is used for processing a collision among different resource scheduling types (such as, dynamic scheduling, semi-static scheduling).

Alternatively, or in addition, in some example embodiments, any of the first and second collision rules is used for processing a collision among different transmission channel types (such as. PUCCH, PUSCH, PDCCH, PDSCH).

Alternatively, or in addition, in some example embodiments, any of the first and second collision rules is used for processing a collision among different transmission signalling types (such as, SSB, CSI-RS, SR, HARQ-ACK, SRS and so on).

In some example embodiments, the first or the second collision rule indicates at least one of the following:
a priority of a communication associated with the first communication direction is higher than a priority of a communication associated with the second communication direction,
a priority of a communication associated with a first resource scheduling type is at least higher than a priority of a communication associated with a second resource scheduling type,
a priority of a communication associated with a first transmission channel type is at least higher than a priority of a communication associated with a second transmission channel type,
a priority of a communication associated with a first transmission signalling type is at least higher than a priority of a communication associated with a second transmission signalling type, or
a priority of a communication associated with both a first transmission signalling type and a first transmission channel type is at least higher than a priority of a communication associated with both a second transmission signalling type and a second transmission channel type.

In one example embodiment, the different handling rules are specified such that, for any collision in the first set, DL transmission is always prioritized, and for any collision in the second set, UL transmission is always prioritized.

In another example embodiment, the different handling rules are specified such that, for any collision in the first set, a subset of DL transmissions (e.g., PDCCH, SSB, CSI-RS, etc.) is prioritized, and for any collision in the second set, a subset of UL transmissions (e.g., PUCCH carrying SR and/or HARQ-ACK, SRS, etc.) is prioritized.

In some example embodiments, at least one of the first and second collision rules is valid within one or more time periods. In one example embodiment, the determination of the collision handling rules may further depend on a time duration (e.g., one system frame number or a number of slots/symbols).

In some example embodiments, the one or more time periods are determined based at least in part on one of the following: a system frame index, a slot index, or a symbol index.

In one example embodiment, the at least one of the first and second collision rules (the collision handling approach discussed herein) is only applicable for those transmissions in even/odd frame number. Otherwise, default collision handling rules are applied.

In another example embodiment, the at least one of the first and second collision rules (the collision handling approach discussed herein) is only applicable if the following condition is satisfied: mod(SFN, K)=C, where K and C are hardcoded in specification or configured by NW. Otherwise, default collision handling rules are applied.

In the following, the first apparatus 110 detects 240-1 a collision occurring on a resource of the plurality of resources. Accordingly, the second apparatus 120 also should detects 240-2 the collision occurring on a resource of the plurality of resources accordingly.

Optionally, before detecting collision, the second apparatus 120 may schedules/configures 230 a DL transmission and a UL transmission with the same priority in SBFD slots, wherein collision may happen between the UL and DL transmissions.

As one example embodiment, the first apparatus 110 may determine whether a collision among UL and DL happens in a SBFD slot or not. In case of collision, the first apparatus 110 may further determine whether the new feature of differentiation of collision handling rules should be applied or not.

In one example embodiment, this could be implemented by checking the RRC parameter for M or the bitmap is configured or not. In case these RRC parameter is not configured, the feature is not applied.

In another example, a separate RRC parameter is used for indicating whether the feature is applied or not. In this case, if the RRC parameter for M or the bitmap is not configured, a default value for M or a default bitmap is used.

In case the new feature is used, the first apparatus 110 may determine whether the SBFD slot belongs to the first or the second set of SBFD slots by checking M or the bitmap.

Then, as illustrated in FIG. 2, the first apparatus 110 and the second apparatus 120 perform 250 communications on the resource based at least in part on the configuration information. That is, the first apparatus 110 applies the corresponding collision handling rules associated to the determined set of SBFD slots. As a result, the first apparatus 110 transmits (or receives) the UL (or DL) transmission following the outcome of collision resolution.

In some embodiments, as for the first set, if UL/DL collision happens (and they are of the same priority index/level), DL is prioritized. Accordingly, as for the second set, if UL/DL collision happens (and they are of the same priority index/level), UL is prioritized.

In this way, a more practicable and flexible solution for collision handling is achieved.

In some example embodiments, when performing the communications with the second apparatus 120, the first apparatus 110 may dropping a communication associated with a lower priority if the communication associated with the lower priority and a further communication associated with a higher priority are collided.

In other words, in case of a collision, the communications (such as, DL/UP transmission, a specific channel, a subset of DL/UP transmission and so on) without being prioritized/with lower priority may be dropped.

Optionally, in some example embodiments, the second apparatus 120 may transmit 210 a resource configuration to the first apparatus 110 (such as, RRC or DCI). As one example embodiment, in case that the plurality of resources are a plurality of SBFD time resources, the resource configuration may indicate at least one of the following:
a frequency band;
a number of slots/symbols wherein the frequency band is split into multiple sub-bands and wherein at least one subband is used for DL transmissions and at least one subband is used for UL transmissions, i.e., sub-band full duplex (SBFD) slots/symbols, and locations of the number of slots/symbols in a radio frame;
a number of slots/symbols wherein the entire frequency band is used for DL transmissions or UL transmissions, i.e., non-SBFD slots/symbols, and locations of the number of slots/symbols in a radio frame.

It should be understood, the resource configuration may comprise other parameters according to the specific recourse types. The present disclosure is not limited in this regard.

In an embodiment, frequency ranges are defined for each of DL and UL sub-bands. Then, some alternatives may include that 1) DL subband is split into at least two ranges (or, to be generic, two sets of RBs), wherein DL transmissions belonging to different ranges that collide with any UL transmission are handled with different collision rules, 2) UL subband is split into at least two ranges (or, to be generic, two sets of RBs), wherein UL transmissions belonging to different ranges that collide with any DL transmission are handled with different collision rules, and/or 3) Each DL and UL subband are split into at least two ranges (or, to be generic, two sets of RBs), wherein collision of DL and UL transmissions belonging to different pairs of ranges are handled with different collision rules. In an embodiment, there is, a first subband (=certain frequency range) within an SBFD bandwidth which prioritizes DL transmissions and another subband (=certain other frequency range) within SBFD bandwidth which prioritizes UL transmissions. These frequency ranges may be indicated to the other communication party as part of the configuration information.

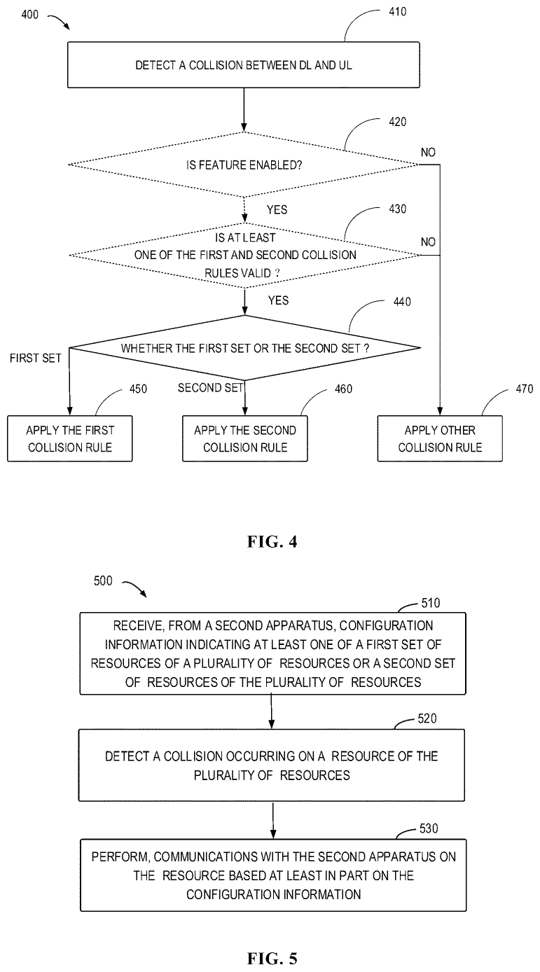

Merely for better understanding, reference is now made to FIG. 4, which illustrates a flowchart 400 of a method implemented at a first device according to some example embodiments of the present disclosure.

At block 410, the first apparatus 110 detects a collision between DL and UP. Optionally, at block 420, the first apparatus 110 determines whether the feature is enabled (the at least one of the first and second collision rules/the collision handling approach discussed herein is enabled/applied). If not, the first apparatus 110 applies other collision rule (such as, a default collision rule) at block 470.

Optionally, at block 430, the first apparatus 110 determines whether at least one of the first and second collision rules is valid (such as, within the one or more time periods). If not, the first apparatus 110 applies other collision rule (such as, a default collision rule) at block 470.

At block 440, the first apparatus 110 determines whether the collision is occurred on the first set or the second set. If the collision is occurred on the first set, the first apparatus 110 applies the first collision rule at block 450. Accordingly, if the collision is occurred on the second set, the first apparatus 110 applies the second collision rule at block 460.

### Example Methods

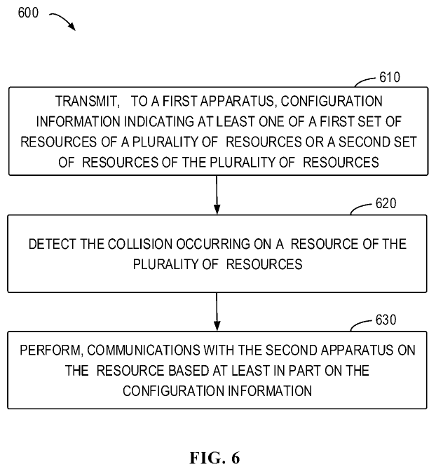

FIG. 5 shows a flowchart of an example method 500 implemented at a first device in accordance with some example embodiments of the present disclosure. For the purpose of discussion, the method 500 will be described from the perspective of the first apparatus 110 in FIG. 1.

At block 510, the first apparatus receives, from a second apparatus, configuration information indicating at least one of a first set of resources of a plurality of resources or a second set of resources of the plurality of resources, the first and second sets of resources associated with a first and second collision rules respectively, the first and second collision rules used for handling a collision between a first communication direction and a second communication direction.

At block 520, the first apparatus detects a collision occurring on a resource of the plurality of resources.

At block 530, the first apparatus performs, communications with the second apparatus on the resource based at least in part on the configuration information.

In some example embodiments, resources in any of the first and second sets of resources are continuous or discontinuous.

In some example embodiments, the configuration information comprises: a number M, indicating that the first M or the last M resources of the plurality of resources belong to the first set of resource and other resources of the plurality of resources belong to the second set of resources.

In some example embodiments, the configuration information comprises: a bitmap of the plurality of resources, each bit in the bitmap corresponding to a resource, and wherein a first value of the bit indicates the corresponding resource belongs to the first set of resource and a second value of the bit indicates the corresponding resource belongs to the second set of resource.

In some example embodiments, any of the first and second collision rules is used for processing a collision among at least one of the following: different communication directions, different resource scheduling types, different transmission channel types, or different transmission signalling types.

In some example embodiments, the first or the second collision rule indicates at least one of the following: a priority of a communication associated with the first communication direction is higher than a priority of a communication associated with the second communication direction, a priority of a communication associated with a first resource scheduling type is at least higher than a priority of a communication associated with a second resource scheduling type, a priority of a communication associated with a first transmission channel type is at least higher than a priority of a communication associated with a second transmission channel type, a priority of a communication associated with a first transmission signalling type is at least higher than a priority of a communication associated with a second transmission signalling type, or a priority of a communication associated with both a first transmission signalling type and a first transmission channel type is at least higher than a priority of a communication associated with both a second transmission signalling type and a second transmission channel type.

In some example embodiments, at least one of the first and second collision rules is valid within one or more time periods.

In some example embodiments, performing the communications comprises: dropping a communication associated with a lower priority if the communication associated with the lower priority and a further communication associated with a higher priority are collided.

In some example embodiments, the one or more time periods are determined based at least in part on one of the following: a system frame index, a slot index, or a symbol index.

In some example embodiments, the configuration information further comprises an indication used for activating at least one of the first and second collision rules.

In some example embodiments, if the configuration information does not comprise explicit information indicating at least one of the first and second sets of resources, the at least one memory and the at least one processor further cause the first apparatus to perform: determine the at least one of the first and second sets of resources according to a default configuration.

In some example embodiments, the plurality of resources are one the following: a plurality of subband non-overlapping full duplex time resources, a plurality of dynamic time division duplexing time resources, a plurality of full duplex evolution time resources, a plurality of sub-bands, a plurality of sub-carriers, or a plurality of resource elements.

In some example embodiments, the first apparatus is a terminal apparatus and the second apparatus is a network apparatus.

FIG. 6 shows a flowchart of an example method 600 implemented at a second device in accordance with some example embodiments of the present disclosure. For the purpose of discussion, the method 600 will be described from the perspective of the second apparatus 120 in FIG. 1.

At block 610, the second apparatus transmits, to a first apparatus, configuration information indicating at least one of a first set of resources of a plurality of resources or a second set of resources of the plurality of resources, the first and second sets of resources associated with a first and second collision rules respectively, the first and second collision rules used for handling a collision between a first communication direction and a second communication direction.

At block 620, the second apparatus detects the collision occurring on a resource of the plurality of resources.

At block 630, the second apparatus performs, communications with the second apparatus on the resource based at least in part on the configuration information.

In some example embodiments, resources in any of the first and second sets of resources are continuous or discontinuous in domain.

In some example embodiments, the configuration information comprises: a number M, indicating that the first M or the last M resources of the plurality of resources belong to the first set of resource and other resources of the plurality of resources belong to the second set of resources.

In some example embodiments, the configuration information comprises: a bitmap of the plurality of resources, each bit in the bitmap corresponding to a resource, and wherein a first value of the bit indicates the corresponding resource belongs to the first set of resource and a second value of the bit indicates the corresponding resource belongs to the second set of resource.

In some example embodiments, any of the first and second collision rules is used for processing a collision among at least one of the following: different communication directions, different resource scheduling types, different transmission channel types, or different transmission signalling types.

In some example embodiments, the first or the second collision rule indicates at least one of the following: a priority of a communication associated with the first communication direction is higher than a priority of a communication associated with the second communication direction, a priority of a communication associated with a first resource scheduling type is at least higher than a priority of a communication associated with a second resource scheduling type, a priority of a communication associated with a first transmission channel type is at least higher than a priority of a communication associated with a second transmission channel type, a priority of a communication associated with a first transmission signalling type is at least higher than a priority of a communication associated with a second transmission signalling type, or a priority of a communication associated with both a first transmission signalling type and a first transmission channel type is at least higher than a priority of a communication associated with both a second transmission signalling type and a second transmission channel type.

In some example embodiments, at least one of the first and second collision rules is valid within one or more time periods.

In some example embodiments, performing the communications comprises: dropping a communication associated with a lower priority if the communication associated with the lower priority and a further communication associated with a higher priority are collided.

In some example embodiments, the one or more time periods are determined based at least in part on one of the following: a system frame index, a slot index, or a symbol index.

In some example embodiments, the configuration information further comprises an indication used for activating at least one of the first and second collision rules.

In some example embodiments, if the configuration information does not comprise explicit information indicating at least one of the first and second sets of resources, the at least one memory and the at least one processor further cause the second apparatus to perform: determine the at least one of the first and second sets of resources according to a default configuration.

In some example embodiments, the plurality of resources are one the following: a plurality of subband non-overlapping full duplex time resources, a plurality of dynamic time division duplexing time resources, a plurality of full duplex evolution time resources, a plurality of sub-bands, a plurality of sub-carriers, or a plurality of resource elements.

In some example embodiments, the first apparatus is a terminal apparatus and the second apparatus is a network apparatus.

### Example Apparatus, Device and Medium

In some example embodiments, a first apparatus capable of performing any of the method 500 (for example, the first the second apparatus 110 in FIG. 1A may comprise means for performing the respective operations of the method 500. The means may be implemented in any suitable form. For example, the means may be implemented in a circuitry or software module. The first apparatus may be implemented as or included in the first the second apparatus 110 in FIG. 1.

In some example embodiments, the first apparatus comprises means for receiving, from a second apparatus, configuration information indicating at least one of a first set of resources of a plurality of resources or a second set of resources of the plurality of resources, the first and second sets of resources associated with a first and second collision rules respectively, the first and second collision rules used for handling a collision between a first communication direction and a second communication direction; means for detecting a collision occurring on a resource of the plurality of resources; and means for performing, communications with the second apparatus on the resource based at least in part on the configuration information.

In some example embodiments, resources any of the first and second sets of resources are continuous or discontinuous in domain.

In some example embodiments, the configuration information comprises: means for a number M, indicating that the first M or the last M resources of the plurality of resources belong to the first set of resource and other resources of the plurality of resources belong to the second set of resources.

In some example embodiments, the configuration information comprises: a bitmap of the plurality of resources, each bit in the bitmap corresponding to a resource, and wherein a first value of the bit indicates the corresponding resource belongs to the first set of resource and a second value of the bit indicates the corresponding resource belongs to the second set of resource.

In some example embodiments, any of the first and second collision rules is used for processing a collision among at least one of the following: different communication directions, different resource scheduling types, different transmission channel types, or different transmission signalling types.

In some example embodiments, the first or the second collision rule indicates at least one of the following: a priority of a communication associated with the first communication direction is higher than a priority of a communication associated with the second communication direction, a priority of a communication associated with a first resource scheduling type is at least higher than a priority of a communication associated with a second resource scheduling type, a priority of a communication associated with a first transmission channel type is at least higher than a priority of a communication associated with a second transmission channel type, a priority of a communication associated with a first transmission signalling type is at least higher than a priority of a communication associated with a second transmission signalling type, or a priority of a communication associated with both a first transmission signalling type and a first transmission channel type is at least higher than a priority of a communication associated with both a second transmission signalling type and a second transmission channel type.

In some example embodiments, means for performing the communications comprises: means for dropping a communication associated with a lower priority if the communication associated with the lower priority and a further communication associated with a higher priority are collided.

In some example embodiments, at least one of the first and second collision rules is valid within one or more time periods.

In some example embodiments, the one or more time periods are determined based at least in part on one of the following: a system frame index, a slot index, or a symbol index.

In some example embodiments, the configuration information further comprises an indication used for activating at least one of the first and second collision rules.

In some example embodiments, if the configuration information does not comprise explicit information indicating at least one of the first and second sets of resources, the at least one memory and the at least one processor further cause the first apparatus to perform: determine the at least one of the first and second sets of resources according to a default configuration.

In some example embodiments, the plurality of resources are one the following: a plurality of subband non-overlapping full duplex time resources, a plurality of dynamic time division duplexing time resources, a plurality of full duplex evolution time resources, a plurality of sub-bands, a plurality of sub-carriers, or a plurality of resource elements.

In some example embodiments, the first apparatus is a terminal apparatus and the second apparatus is a network apparatus.

In some example embodiments, the first apparatus further comprises means for performing other operations in some example embodiments of the method 500 or the first device 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second the second apparatus 120 in FIG. 1A may comprise means for performing the respective operations of the method 600. The means may be implemented in any suitable form. For example, the means may be implemented in a circuitry or software module. The second apparatus may be implemented as or included in the second the second apparatus 120 in FIG. 1.

In some example embodiments, the second apparatus comprises means for transmitting, to a first apparatus, configuration information indicating at least one of a first set of resources of a plurality of resources or a second set of resources of the plurality of resources, the first and second sets of resources associated with a first and second collision rules respectively, the first and second collision rules used for handling a collision between a first communication direction and a second communication direction; means for detecting the collision occurring on a resource of the plurality of resources; and means for performing, communications with the second apparatus on the resource based at least in part on the configuration information.

In some example embodiments, resources in any of the first and second sets of resources are continuous or discontinuous.

In some example embodiments, the configuration information comprises: means for a number M, indicating that the first M or the last M resources of the plurality of resources belong to the first set of resource and other resources of the plurality of resources belong to the second set of resources.

In some example embodiments, the configuration information comprises: a bitmap of the plurality of resources, each bit in the bitmap corresponding to a resource, and wherein a first value of the bit indicates the corresponding resource belongs to the first set of resource and a second value of the bit indicates the corresponding resource belongs to the second set of resource.

In some example embodiments, any of the first and second collision rules is used for processing a collision among at least one of the following: different communication directions, different resource scheduling types, different transmission channel types, or different transmission signalling types.

In some example embodiments, the first or the second collision rule indicates at least one of the following: a priority of a communication associated with the first communication direction is higher than a priority of a communication associated with the second communication direction, a priority of a communication associated with a first resource scheduling type is at least higher than a priority of a communication associated with a second resource scheduling type, a priority of a communication associated with a first transmission channel type is at least higher than a priority of a communication associated with a second transmission channel type, a priority of a communication associated with a first transmission signalling type is at least higher than a priority of a communication associated with a second transmission signalling type, or a priority of a communication associated with both a first transmission signalling type and a first transmission channel type is at least higher than a priority of a communication associated with both a second transmission signalling type and a second transmission channel type.

In some example embodiments, means for performing the communications comprises: means for dropping a communication associated with a lower priority if the communication associated with the lower priority and a further communication associated with a higher priority are collided.

In some example embodiments, at least one of the first and second collision rules is valid within one or more time periods.

In some example embodiments, the one or more time periods are determined based at least in part on one of the following: a system frame index, a slot index, or a symbol index.

In some example embodiments, the configuration information further comprises an indication used for activating at least one of the first and second collision rules.

In some example embodiments, if the configuration information does not comprise explicit information indicating at least one of the first and second sets of resources, the at least one memory and the at least one processor further cause the second apparatus to perform: determine the at least one of the first and second sets of resources according to a default configuration.

In some example embodiments, the plurality of resources are one the following: a plurality of subband non-overlapping full duplex time resources, a plurality of dynamic time division duplexing time resources, a plurality of full duplex evolution time resources, a plurality of sub-bands, a plurality of sub-carriers, or a plurality of resource elements.

In some example embodiments, the first apparatus is a terminal apparatus and the second apparatus is a network apparatus.

In some example embodiments, the second apparatus further comprises means for performing other operations in some example embodiments of the method 600 or the second the second apparatus 120. In some example embodiments, the means comprises at least one processor; and at least one memory storing instructions that, when executed by the at least one processor, cause the performance of the second apparatus.

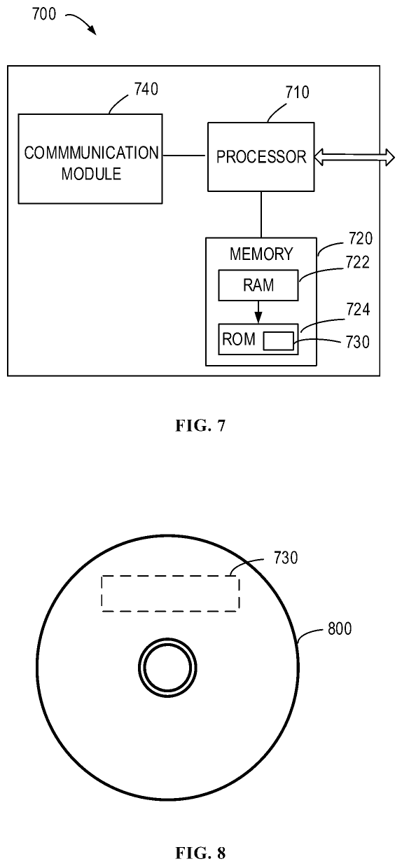

FIG. 7 is a simplified block diagram of a device 700 that is suitable for implementing example embodiments of the present disclosure. The device 700 may be provided to implement a communication device, for example, the first the second apparatus 110 or the second the second apparatus 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-29. (canceled)

30. A first apparatus comprising:
at least one processor; and
at least one memory storing instructions that, when executed by the at least one processor, cause the first apparatus operating in a subband full duplex (SBFD) communication system, to:
receive, from a second apparatus comprising a network device, via radio resource control (RRC) signaling, configuration information indicating a bundle of N SBFD slots and further indicating a first set of SBFD slots and a second set of SBFD slots within the bundle, wherein the first set and the second set are defined by:
a bitmap of size N in which each bit corresponds to a respective SBFD slot and indicates membership in the first set or the second set, and a parameter M indicating that either a first M SBFD slots or a last M SBFD slots of the bundle belong to the first set and remaining SBFD slots belong to the second set, wherein:
each SBFD slot comprises non-overlapping downlink (DL) subbands and uplink (UL) subbands configured to allow simultaneous DL and UL transmissions, and
the first set of SBFD slots is associated with a first collision rule and
the second set of SBFD slots is associated with a second collision rule;
detect, within a given SBFD slot of the bundle, a collision between a dynamically scheduled uplink transmission and a semi-statically configured downlink transmission occurring on overlapping time resources; and
in response to detecting the collision:
determine whether the given SBFD slot belongs to the first set or the second set based on the configuration information; and
perform communication with the second apparatus by applying:
the first collision rule when the given SBFD slot belongs to the first set, wherein the first collision rule specifies that downlink transmission is prioritized and the uplink transmission is dropped, and
the second collision rule when the given SBFD slot belongs to the second set, wherein the second collision rule specifies that uplink transmission is prioritized and the downlink transmission is dropped, wherein the first collision rule and the second collision rule are applied only when a priority level of the uplink transmission and the downlink transmission is equal.

31. The first apparatus of claim 30, wherein the configuration information further comprises an explicit indication for activating at least one of the first collision rule or the second collision rule.

32. The first apparatus of claim 31, wherein the first apparatus is further caused to determine the first set of SBFD slots and the second set of SBFD slots based on a default configuration when the bitmap and the parameter M are not configured.

33. The first apparatus of claim 32, wherein the collision between the dynamically scheduled uplink transmission and the semi-statically configured downlink transmission corresponds to a scenario in which the downlink transmission is semi-statically configured via RRC signaling and the uplink transmission is dynamically scheduled.

34. The first apparatus of claim 33, wherein the first collision rule and the second collision rule are configured to handle collisions among different transmission channel types comprising: physical uplink control channel (PUCCH), physical uplink shared channel (PUSCH), physical downlink control channel (PDCCH), and physical downlink shared channel (PDSCH).

35. The first apparatus of claim 34, wherein the first collision rule specifies that a subset of downlink transmissions comprising PDCCH, synchronization signal block (SSB), and channel state information reference signal (CSI-RS) is prioritized over uplink transmissions.

36. The first apparatus of claim 35, wherein the second collision rule specifies that a subset of uplink transmissions comprising PUCCH carrying scheduling request (SR) and hybrid automatic repeat request acknowledgment (HARQ-ACK), or sounding reference signal (SRS), is prioritized over downlink transmissions.

37. The first apparatus of claim 36, wherein the first collision rule and the second collision rule are applied only within one or more time periods determined based on: a system frame number (SFN), a slot index, and a symbol index.

38. The first apparatus of claim 37, wherein the one or more time periods are defined such that the first collision rule and the second collision rule are applied only when mod(SFN, K)=C, where K and C are predefined or configured parameters.

39. The first apparatus of claim 38, wherein performing the communication further comprises dropping a transmission associated with a lower priority when the lower priority transmission collides with a higher priority transmission in the given SBFD slot.

40. The first apparatus of claim 39, wherein the first and second collision rules are used for processing a collision among:
different communication directions,
different resource scheduling types,
different transmission channel types, and
different transmission signalling types.

41. A method performed by a first apparatus operating in a subband full duplex (SBFD) communication system, the method comprising:
receiving, from a second apparatus comprising a network device, via radio resource control (RRC) signaling, configuration information indicating a bundle of N SBFD slots and further indicating a first set of SBFD slots and a second set of SBFD slots within the bundle, wherein the first set and the second set are defined by:
a bitmap of size N in which each bit corresponds to a respective SBFD slot and indicates membership in the first set or the second set, and a parameter M indicating that either a first M SBFD slots or a last M SBFD slots of the bundle belong to the first set and remaining SBFD slots belong to the second set,
wherein:
each SBFD slot comprises non-overlapping downlink (DL) subbands and uplink (UL) subbands configured to allow simultaneous DL and UL transmissions, and
the first set of SBFD slots is associated with a first collision rule and the second set of SBFD slots is associated with a second collision rule;
detecting, within a given SBFD slot of the bundle, a collision between a dynamically scheduled uplink transmission and a semi-statically configured downlink transmission occurring on overlapping time resources; and
in response to detecting the collision:
determining whether the given SBFD slot belongs to the first set or the second set based on the configuration information; and
perform communication with the second apparatus by applying:
the first collision rule when the given SBFD slot belongs to the first set, wherein the first collision rule specifies that downlink transmission is prioritized and the uplink transmission is dropped, and
the second collision rule when the given SBFD slot belongs to the second set, wherein the second collision rule specifies that uplink transmission is prioritized and the downlink transmission is dropped, wherein the first collision rule and the second collision rule are applied only when a priority level of the uplink transmission and the downlink transmission is equal.

42. The method of claim 41, wherein the configuration information further comprises an explicit indication for activating at least one of the first collision rule or the second collision rule.

43. The method of claim 42, further comprising: determining the first set of SBFD slots and the second set of SBFD slots based on a default configuration when the bitmap and the parameter M are not configured.

44. The method of claim 43, wherein the collision between the dynamically scheduled uplink transmission and the semi-statically configured downlink transmission corresponds to a scenario in which the downlink transmission is semi-statically configured via RRC signaling and the uplink transmission is dynamically scheduled.

45. The method of claim 44, wherein the first collision rule and the second collision rule are configured to handle collisions among different transmission channel types comprising: physical uplink control channel (PUCCH), physical uplink shared channel (PUSCH), physical downlink control channel (PDCCH), and physical downlink shared channel (PDSCH).

46. The method of claim 45, wherein the first collision rule specifies that a subset of downlink transmissions comprising PDCCH, synchronization signal block (SSB), and channel state information reference signal (CSI-RS) is prioritized over uplink transmissions.

47. The method of claim 46, wherein the second collision rule specifies that a subset of uplink transmissions comprising PUCCH carrying scheduling request (SR) and hybrid automatic repeat request acknowledgment (HARQ-ACK), or sounding reference signal (SRS), is prioritized over downlink transmissions.

48. The method of claim 47, wherein the first collision rule and the second collision rule are applied only within one or more time periods determined based on: a system frame number (SFN), a slot index, and a symbol index.

49. The method of claim 48, wherein the first and second collision rules are used for processing a collision among:
different communication directions,
different resource scheduling types,
different transmission channel types, and
different transmission signalling types.
